(19) United States
(12) Patent Application Publication
(10) Pub. No.: US 2009/0251404 A1
(43) Pub. Date: Oct. 8, 2009

(54) ELECTROPHORETIC DISPLAY AND DRIVING METHOD THEREOF

(75) Inventors: Hyun-Sik HWANG, Ansan-si (KR); Cheol-Woo PARK, Suwon-si (KR); Joo-Young KIM, Suwon-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/111,679

(22) Filed: Apr. 29, 2008

(30) Foreign Application Priority Data
Apr. 3, 2008 (KR) 10-2008-0031199

(51) Int. Cl. G09G 3/34

(52) U.S. Cl. 345/107

(57) ABSTRACT

An electrophoretic display includes first and second gate lines, a data line that crosses the first and second gate lines, a first pixel connected to the first gate line and the data line, and a second pixel positioned on the opposite side of the data line from the first pixel and connected to the second gate line and the data line.

### CROSS-REFERENCE TO RELATED APPLICATION

This application claims priority to and the benefit of Korean Patent Application No. 10-2008-0031199, filed on Apr. 3, 2008, the entire contents of which are incorporated herein by reference.

### BACKGROUND OF THE INVENTION

1. Field of the Invention

The present invention relates to an electrophoretic display and a method for driving the electrophoretic display.

2. Description of the Background

An electrophoretic display (EPD) is being actively studied, together with a liquid crystal display (LCD), an organic light emitting device (OLED), and the like, as a flat panel display device.

An electrophoretic display includes a plurality of pixels including an electrophoretic material and switching elements, signal lines such as gate lines and data lines to apply signals to the switching elements, drivers to generate signals to be applied to the signal lines, a signal controller to control the drivers, and the like.

Generally, the drivers include a plurality of integrated circuit (IC) chips, but currently, a gate driver, which generates gate signals, is usually integrated on a display panel with pixels and signal lines formed thereon, instead of being formed as an IC chip.

Because the data driver's structure is more complicated than the gate drivers, it may be difficult to integrate the data driver on the display panel. Thus, the data driver is commonly formed as an IC chip. But the data driver IC chip is expensive, which makes it difficult to reduce the unit fabrication cost of the electrophoretic display.

In addition, because the voltage used for data signals of the electrophoretic display is higher than that of other flat panel displays such as the liquid crystal display, etc., the electrophoretic display consumes relatively more power.

### SUMMARY OF THE INVENTION

The present invention provides an electrophoretic display and method of manufacturing the same.

Additional features of the invention will be set forth in the description which follows, and in part will be apparent from the description, or may be learned by practice of the invention.

The present invention discloses an electrophoretic display including first and second gate lines, a data line that crosses the first and second gate lines, a first pixel connected to the first gate line and the data line, and a second pixel connected to the second gate line and the data line. The second pixel and the first pixel are on opposite sides of the data line from each other.

The present invention also discloses an electrophoretic display including a plurality of pixels including a plurality of pixel rows having odd-numbered pixels and even-numbered pixels, a first gate line connected to the odd-numbered pixels to transfer a first gate signal to the odd-numbered pixels, a second gate line connected to the even-numbered pixels to transfer a second gate signal to the even-numbered pixels, a data line crossing the first and second gate lines and connected to both the odd-numbered pixels and the even-numbered pixels in the respective pixel rows, a gate driver to apply first and second gate signals to the first and second gate lines, and a data driver to apply data voltages to the data lines and including at least one IC chip.

The present invention also discloses a method for driving an electrophoretic display. The method includes charging first data voltages to odd-numbered pixels of a pixel row by applying a gate-on voltage to a first gate line via a first part of a gate driver and applying the first data voltages to data lines, and charging second data voltages to even-numbered pixels of the pixel row by applying the gate-on voltage to a second gate line via a second part of the gate driver and applying the second data voltages to the data lines.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 and FIG. 2 are block diagrams of an electrophoretic display according to an exemplary embodiment of the present invention.

FIG. 3 is an equivalent circuit diagram of a pixel of the electrophoretic display according to an exemplary embodiment of the present invention.

FIG. 4 is a schematic cross-sectional view of the electrophoretic display according to an exemplary embodiment of the present invention.

FIG. 5 shows waveforms of the electrophoretic display according to an exemplary embodiment of the present invention.

FIG. 6, FIG. 7, FIG. 8, and FIG. 9 are schematic diagrams showing operation principles of a gate driver and pixels in the electrophoretic display of FIG. 5.

FIG. 10 shows waveforms of an electrophoretic display according to another exemplary embodiment of the present invention.

### DETAILED DESCRIPTION OF THE ILLUSTRATED EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

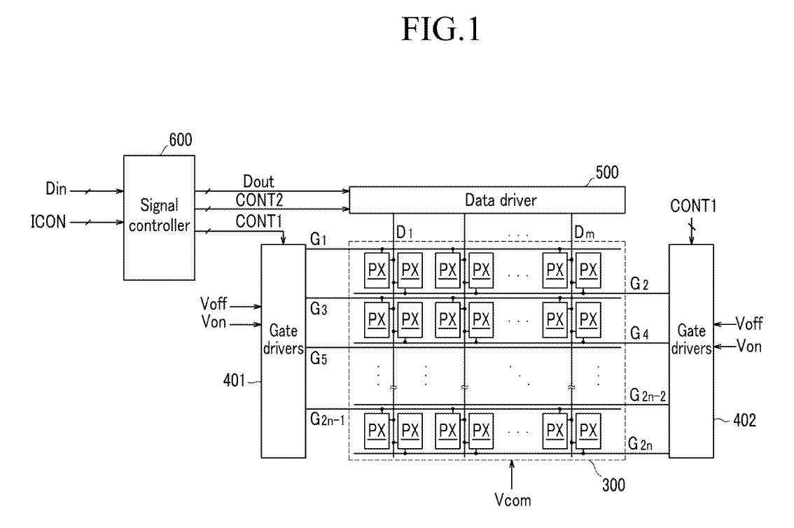

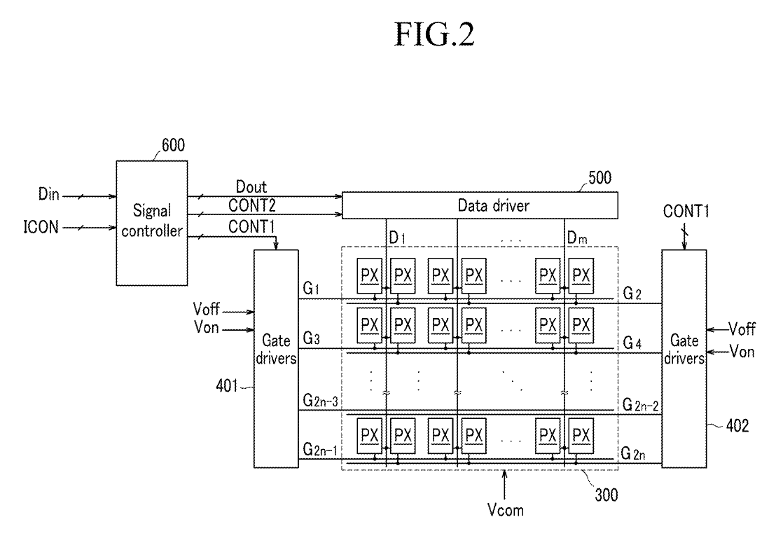

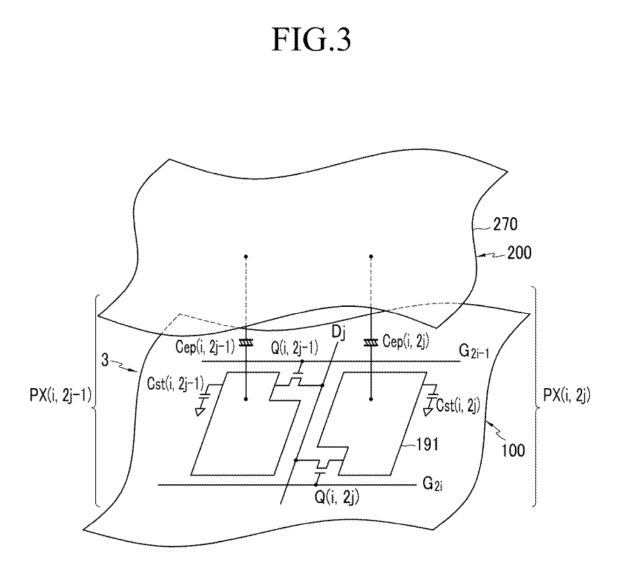

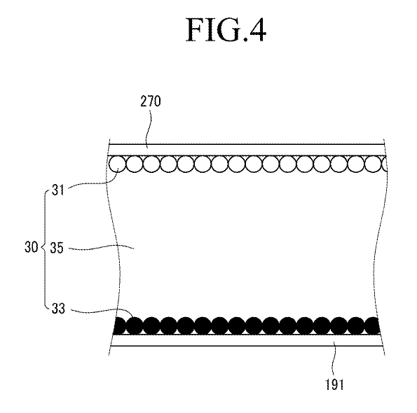

An electrophoretic display according to an exemplary embodiment of the present invention will now be described in detail with reference to FIG. 1, FIG. 2, FIG. 3, and FIG. 4.

FIG. 1 and FIG. 2 are block diagrams of an electrophoretic display according to an exemplary embodiment of the present invention, FIG. 3 is an equivalent circuit diagram of a pixel of the electrophoretic display according to an exemplary embodiment of the present invention, and FIG. 4 is a schematic cross-sectional view of the electrophoretic display according to an exemplary embodiment of the present invention.

Referring to FIG. 1 and FIG. 2, an electrophoretic display device according to an exemplary embodiment of the present invention includes a display panel unit 300, gate drivers 401 and 402, a data driver 500, and a signal controller 600.

According to an equivalent circuit as shown in FIG. 1, FIG. 2, and FIG. 3, the display panel unit 300 includes a plurality of signal lines G₁-G₂ₙ and D₁-Dₘ, and a plurality of pixels PX arranged substantially in a matrix form. According to the structure as shown in FIG. 3 and FIG. 4, the display panel unit 300 includes lower and upper display panels 100 and 200, and an electrophoretic layer 3 interposed between the lower and upper display panels 100 and 200.

The signal lines include a plurality of gate lines G₁-G₂ₙ that transfer gate signals and a plurality of data lines D₁-Dₘ that transfer data voltages.

The gate lines G₁-G₂ₙ extend substantially in a row direction, and there are twice as many gate lines G₁-G₂ₙ as pixel rows. The gate lines G₁-G₂ₙ are paired per pixel PX row such that one line of each pair of gate lines is disposed above a corresponding pixel row and the other line of each pair of gate lines is disposed below the corresponding pixel row (See FIG. 1), or both lines of each pair of gate lines are disposed below a corresponding pixel row (See FIG. 2). Alternatively, both lines of each pair of gate lines G₁-G₂ₙ may be disposed above a corresponding pixel row.

The data lines D₁-Dₘ extend substantially in a column direction, and there are half as many data lines D₁-Dₘ as pixel PX columns. The data lines D₁-Dₘ are disposed such that one data line is provided per two pixel rows. That is, the data lines D₁-Dₘ are disposed between two pixel columns, namely, between an odd-numbered pixel column and the next even-numbered pixel column.

The pixels PX of the odd-numbered columns and the pixels PX of the even-numbered columns positioned left and right of the data lines D₁-Dₘ are connected to the same data lines D₁-Dₘ. In addition, the pixels PX of the odd-numbered columns and the pixels PX of the even-numbered columns are connected to different gate lines G₁-G₂ₙ. For example, the pixels PX of the odd-numbered columns are connected to the odd-numbered gate lines G₁, G₃, . . . , and G₂ₙ₋₁, and the pixels PX of the even-numbered columns are connected to the even-numbered gate lines G₂, G₄, . . . , and G₂ₙ.

Referring to FIG. 3, each pixel PX includes a switching element Q, an electrophoretic capacitor Cep, and a storage capacitor Cst.

FIG. 3 shows two pixels [PX (i,2j−1), PX (i,2j)] connected to the jth data line Dⱼ at the ith (i=1, 2, . . . , n) pixel row, namely, the pixel [PX (i,2j−1)] at the (2j−1)th column and the pixel [PX (i,2j)] at the 2jth column. Gate lines G₂ᵢ₋₁ and G₂ᵢ are disposed above and below the two pixels [PX (i,2j−1), PX (i,2j)], respectively. Elements belonging to the pixel [PX (i,2j−1)] include “(i,2j−1)” in their corresponding reference character, and elements belonging to the pixel [PX (i,2j)] include “(i,2j)” in their corresponding reference character.

The switching element Q is three-terminal element such as a thin film transistor, etc., provided at the lower display panel 100. A control terminal of the switching element Q is connected to the gate line G₂ᵢ₋₁ or G₂ᵢ, an input terminal of the switching element Q is connected to the data line Dⱼ, and an output terminal of the switching element Q is connected to the electrophoretic capacitor Cep and the storage capacitor Cst. In FIG. 3, a switching element [Q (i,2j−1)] of the pixel [PX (i,2j−1)] is connected to the gate line G₂ᵢ₋₁ and the data line Dⱼ, and a switching element [Q (i,2j)] of the pixel [PX (i,2j)] is connected to the gate line G₂ᵢ and the data line Dⱼ.

The electrophoretic capacitor Cep uses a pixel electrode 191 of the lower display panel 100 and a common electrode 270 of the upper display panel 200 as two terminals, and the electrophoretic layer 3 between the two electrodes 191 and 270 serves as a dielectric material. The pixel electrode 191 is connected to the switching element Q, and the common electrode 270 may be formed on the entire surface of the upper display panel 200 and receives a common voltage Vcom.

As shown in FIG. 4, the electrophoretic layer 3 may include, for example, white charged particles 31, black charged particles 33, and a transparent dielectric fluid 35. The white particles 31 and the black particles 33 are charged with mutually opposite electric charges. The charged particles 31 and 33 and the transparent dielectric fluid 35 may be encapsulated in a micro-capsule 30.

The storage capacitor Cst, which assists the electrophoretic capacitor Cep, is formed by an overlap of another (separate) signal line (not shown) provided on the lower display panel 100 with the pixel electrode 191, and an insulator interposed therebetween. A voltage, such as the common voltage Vcom, may be applied to the separate signal line. Alternatively, the storage capacitor Cst may be formed by overlapping the pixel electrode 191 with the immediately previous gate line Gᵢ₋₁. The storage capacitor Cst may be omitted.

Referring again to FIG. 1 and FIG. 2, the gate drivers 401 and 402 apply a gate signal, which includes a gate-on voltage Von and a gate-off voltage Voff, to the gate lines G₁-G₂ₙ. The gate drivers 401 and 402 include two parts 401 and 402 that are disposed at left and right edges of the display panel unit 300, respectively. The left part 401 (i.e., the left gate driver) is connected to the odd-numbered gate lines G₁, G₃, . . . , G₂ₙ₋₁, and the right part 402 (i.e., the right gate driver) is connected to the even-numbered gate lines G₂, G₄, . . . , G₂ₙ. The respective gate drivers 401 and 402 may include a plurality of IC chips, or they may be integrated together with the switching elements Q and the signal lines G₁-G₂ₙ and D₁-Dₘ on the display panel unit 300.

One of the gate drivers 401 and 402 may be disposed on either side of the left and right edges the display panel unit 300.

The data driver 500 is connected to the data lines D₁-Dₘ of the display panel unit 300 and applies data voltages to the pixels PX. The data driver 500 may include at least one IC chip, and in this case, because there are half as many data lines D₁-Dₘ as pixel columns, there may be half as many chips as pixel columns.

When the gate drivers 401 and 402 are formed as IC chips, the number of chips of the data driver 500 would be reduced while the number of chips of the gate drivers 401 and 402 would increase. However, because the chips of the gate drivers 401 and 402 are simpler in form than the chips of the data driver 500, they are cheaper, so the overall cost may be reduced.

The signal controller 600 controls operations of the gate drivers 401 and 402 and the data driver 500.

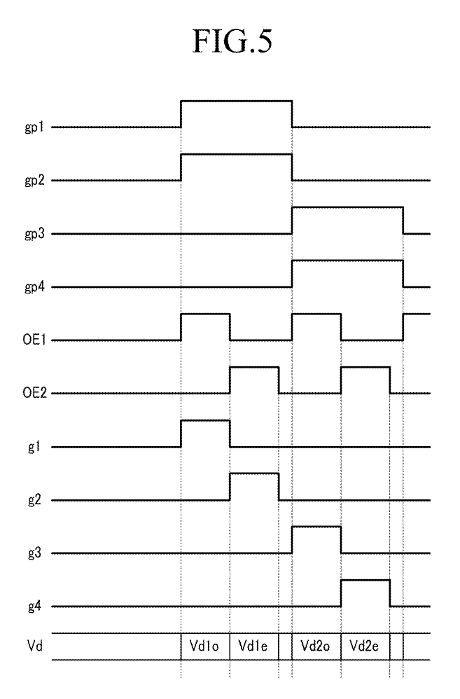

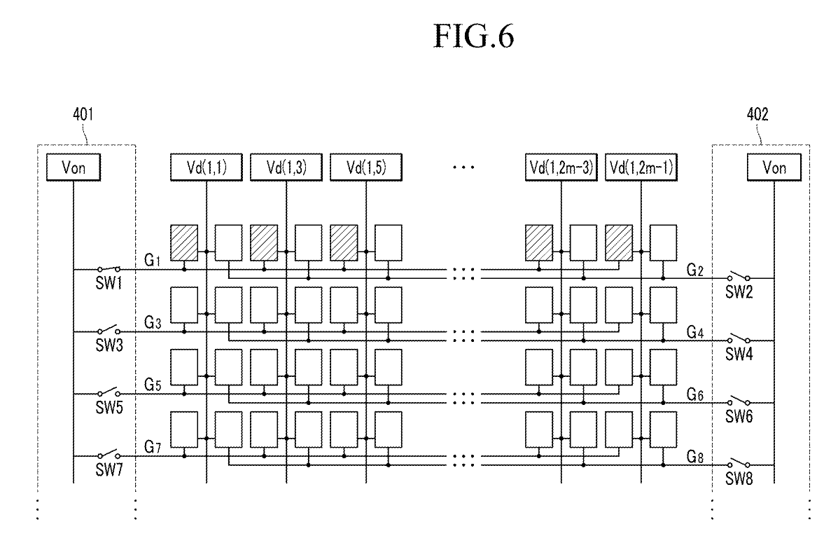

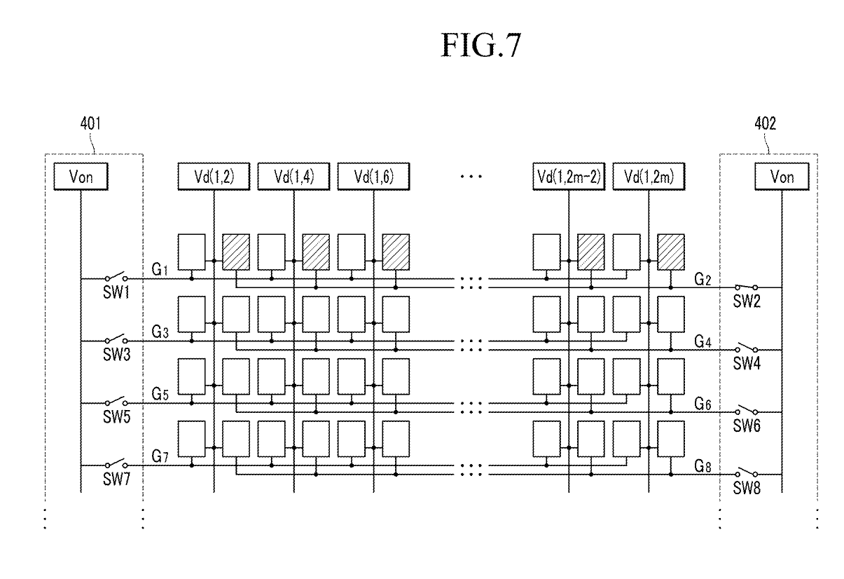

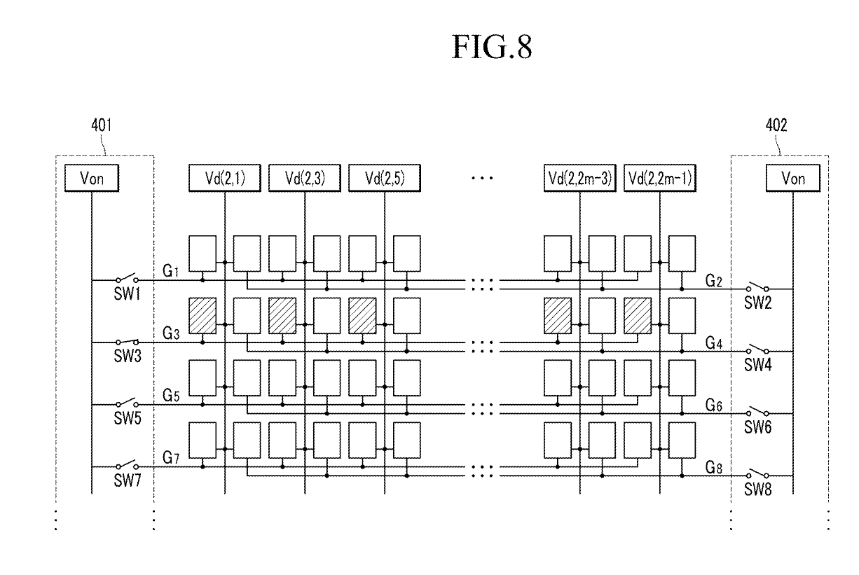

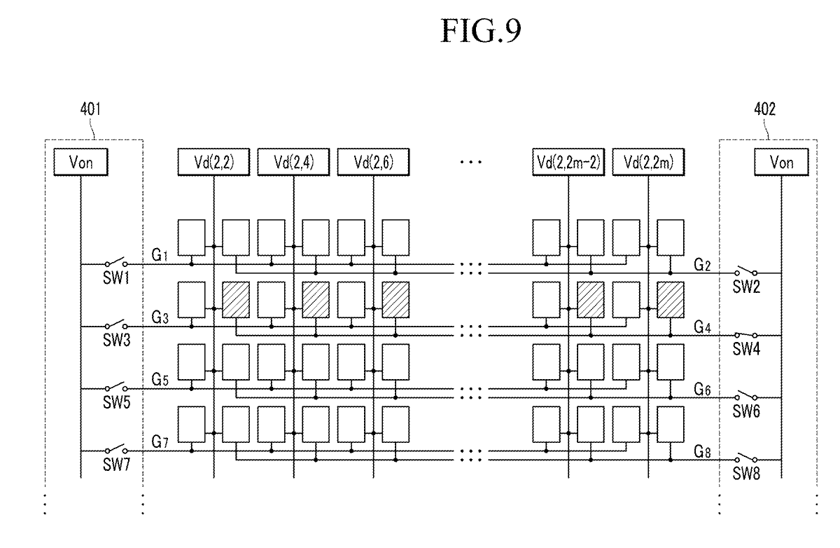

The operation of the electrophoretic display will now be described in detail with reference to FIG. 5, FIG. 6, FIG. 7, FIG. 8, and FIG. 9.

FIG. 5 shows waveforms of the electrophoretic display according to an exemplary embodiment of the present invention, and FIG. 6, FIG. 7, FIG. 8, and FIG. 9 are schematic diagrams showing operation principles of a gate driver and pixels in the electrophoretic display of FIG. 5.

The signal controller 600 receives input image signals Din and input control signals ICON for controlling display of the input image signals Din from an external graphics controller (not shown). The input image signals Din include luminance information of each pixel PX, and the luminance has a predetermined number of gray scales, for example, 1,024 (=210), 256 (=28), or 64 (=26) gray scales. The input control signals ICON may include, for example, a vertical synchronization signal, a horizontal synchronization signal, a main clock signal, a data enable signal, etc.

The signal controller 600 divides the input image signals Din into input image signals corresponding to the odd-numbered pixel columns (referred to as “odd-numbered image signals”, hereinafter), and input image signals corresponding to the even-numbered pixel columns (referred to as “even-numbered image signals”, hereinafter) for each pixel row, and properly processes the image signals Din according to the operational conditions of the display panel unit 300 based on the input control signals ICON. The signal controller 600 generates gate control signals CONT1, data control signals CONT2, etc. The signal controller 600 outputs the gate control signals CONT1 to the gate drivers 401 and 402, and outputs the data control signals CONT2 and the processed image signals Dout to the data driver 500. In this case, as for the image signals Dout, the signal controller 600 separately outputs a number of odd-numbered image signals and a number of even-numbered image signals. For example, the signal controller 500 outputs all the odd-numbered image signals, and then outputs the even-numbered image signals.

The gate control signals CONT1 include a scanning start signal STV for indicating a start of scanning, at least one clock signal for controlling an output time of the gate-on voltage Von of the gate signal, and output enable signals OE1 and OE2 for defining a duration of the gate on-voltage Von. When the two gate drivers 401 and 402 are formed as shown in FIG. 1 and FIG. 2, the scan start signal STV and the clock signal inputted to the gate drivers 401 and 402 may be the same, but the output enable signals OE1 and OE2 may be different.

The data control signals CONT2 include a horizontal synchronization start signal STH informing about transmission of the number of image signals Dout, a load signal LOAD instructing application of data voltages to the data lines D₁-Dₘ, a data clock signal HCLK, etc.

The data driver 500 converts the odd-numbered image signals Dout or the even-numbered image signals Dout into data voltages according to the data control signals CONT2 from the signal controller 600, and applies the converted image signals to corresponding data lines D₁-Dₘ.

The gate drivers 401 and 402 apply the gate-on voltage Von to the gate lines G₁-G₂ₙ according to the gate control signals CONT1 from the signal controller 600. As noted above, the gate drivers 401 and 402 are alternately connected to the gate lines G₁-G₂ₙ, so, for example, the left gate driver 401 applies gate signals g1 and g3 to the first and third gate lines G₁ and G₃, respectively, and the right gate driver 402 applies gate signals g2 and g4 to the second and fourth gate lines G₂ and G₄, respectively.

Referring to FIG. 5, the pre-output gate signals gp1, gp2, gp3, and gp4, which are generated by the gate drivers 401 and 402, are the same as the general gate signals. Further, the pre-output gate signals gp1 and gp2, and gp3 and gp4, which are generated by the gate drivers 401 and 402, are the same. Namely, the pre-output gate signal gp1 with respect to the first gate line G₁ and the pre-output gate signal gp2 with respect to the second gate line G₂ have the same magnitude and duration, and the pre-output gate signal pg3 with respect to the third gate line G₃ and the pre-output gate signal gp4 with respect to the fourth gate line G₄ have the same magnitude and duration. However, the output enable signals OE1 and OE2, which may be transmitted from the signal controller 600, restrict an output time of the gate-on voltage Von. That is, for the pre-output gate signals gp1 and gp3 with respect to the odd-numbered gate lines G₁ and G₃, the output time of the gate-on voltage Von is limited by the first output enable signal OE1, and for the pre-output gate signals gp2 and gp4 with respect to the even-numbered gate lines G₂ and G₄, the output time of the gate-on voltage Von is limited by the second output enable signal OE2.

Here, the first output enable signal OE1 has a high voltage substantially during the first half of the gate-on voltage Von interval of the pre-output gate signals gp1 to gp4, and the second output enable signal OE2 has a high voltage substantially during the latter half of the gate-on voltage Von interval of the pre-output gate signals gp1 to gp4. Because the gate-on voltage Von is supposed to be outputted only when the output enable signals OE1 and OE2 have the high voltage, respectively (or vice versa), the gate-on voltage Von of the pre-output gate signals gp1 and gp3 with respect to the odd-numbered gate lines G₁ and G₃ is outputted only during the first half of the gate-on voltage interval, while the gate-on voltage Von of the pre-output gate signals gp2 and gp4 with respect to the even-numbered gate lines G₂ and G₄ is outputted only during the latter half of the gate-on voltage interval. As a result, the gate signals g1 to g4 having the waveforms as shown in FIG. 5 may be generated.

When the gate-on voltage Von is applied to the gate lines G₁-G₂ₙ, the switching elements Q connected thereto are turned on. Accordingly, a data voltage Vd applied to the data lines D₁-Dₘ is applied to the pixels PX via the turned-on switching elements Q. When the gate-on voltage Von is applied to the odd-numbered gate lines G₁, G₃, . . . and G₂ₙ₋₁, data voltages Vd1o and Vd2o to be applied to the odd-numbered pixels are transmitted by the data lines D₁-Dₘ, and conversely, when the gate-on voltage Von is applied to the even-numbered gate lines G₂, G₄, . . . , and G₂ₙ, data voltages Vd1e and Vd2e to be applied to the even-numbered pixels are transmitted by the data lines D₁-Dₘ.

FIG. 6, FIG. 7, FIG. 8, and FIG. 9 show these processes. The gate drivers 401 and 402 may be considered to be a set of switches SW1 to SW8 connected between the gate lines G₁-G₈ and the gate-on voltage Von.

As shown in FIG. 6, when the switch SW1 connected to the first gate line G₁ is closed, the gate-on voltage Von is applied to the odd-numbered pixels of the first pixel row, and accordingly, corresponding data voltages [Vd (1,1), Vd (1,3), . . . , Vd (1,2m−1)] are charged to corresponding pixels.

Subsequently, with reference to FIG. 7, the switch SW1 is opened, and the switch SW2 connected to the second gate line G₂ is closed. Then, the gate-on voltage Von is applied to the even-numbered pixels of the first pixel row, and accordingly, corresponding data voltages [Vd (1,2, Vd (1,4), . . . , Vd (1,2m)] are charged to corresponding pixels.

With reference to FIG. 8, the switch SW2 is opened, and the switch SW3 connected to the third gate line G₃ is closed. Then, the gate-on voltage Von is applied to the odd-numbered pixels of the second pixel row, and accordingly, corresponding data voltages [Vd (2,1), Vd (2,3), . . . , Vd (2,2m−1)] are charged to corresponding pixels.

As shown in FIG. 9, when the switch SW3 is opened and the switch SW4 connected to the fourth gate line G₄ is closed, the gate-on voltage Von is applied to the even-numbered pixels of the second pixel row and corresponding data voltages [Vd (2,2), Vd (2,4), . . . , Vd (2,2m)] are charged.

By repeatedly performing this process, the gate-on voltage Von may be applied to all the gate lines G₁-G₂ₙ and the data voltage Vd may be applied to all the pixels PX.

When the data voltage Vd is applied to the electrophoretic capacitor Cep, the positions of the charged particles 31 and 33 change, depending on the size, the polarity, an application time, etc.

For example, when the white charged particles 31 are positioned near the common electrode 270, the electrophoretic display displays a white color. Conversely, when black charged particles 33 are positioned near the common electrode 270, the electrophoretic display displays a black color. When the white and black charged particles 31 and 33 are positioned in the middle of the micro-capsule 30, a gray color may be displayed. In this manner, the electrophoretic display may display images of various gray scales by changing the positions of the charged particles 31 and 33.

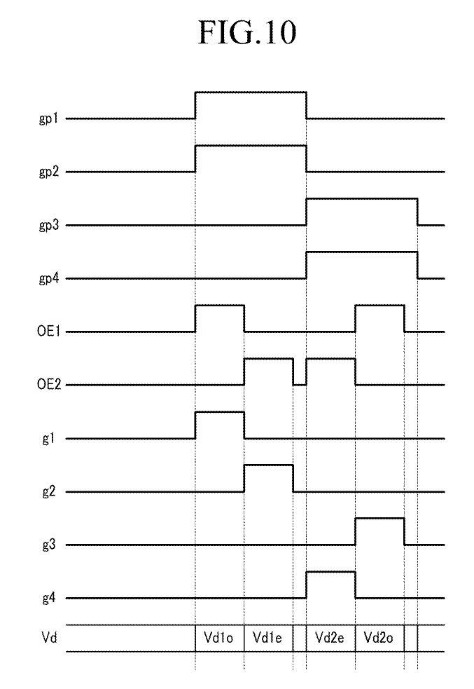

The operation of an electrophoretic display according to another exemplary embodiment of the present invention will be described below with reference to FIG. 10.

FIG. 10 shows waveforms of an electrophoretic display according to another exemplary embodiment of the present invention.

In order to move the charged particles 31 and 33 in the electrophoretic display, a high voltage may be required. Accordingly, a high data voltage Vd may be applied to the data lines D₁-Dₘ, resulting in high power consumption. In this case, when a large difference exists between data voltages Vd of a current pixel row and a next pixel row, power consumption may be further increased. Thus, in order to reduce the difference of the data voltages Vd when pixel rows are changed, the order of applying voltages to the odd-numbered pixels and the even-numbered pixels may change. For example, the average of data voltages Vd applied to the even-numbered pixels of the first pixel row may be compared with the average of the data voltages Vd to be applied to the odd-numbered pixels of the second pixel row and the average of the data voltages Vd to be applied to the even-numbered pixels of the second pixel row. If the difference between the average of the data voltages Vd applied to the even-numbered pixels of the first pixel row and the average of the voltages to be applied to the even-numbered pixels of the second pixel row is the smaller of the two differences, when the data voltage Vd is applied to the second pixel row, the data voltage Vd may be first applied to the even-numbered pixels and then to the odd-numbered pixels.

This can be determined such that the input image signals Din are received from the signal controller 600, and the average of the odd-numbered image signals and that of the even-numbered image signals are calculated and then compared with the average of even-numbered or odd-numbered image signals applied in the previous row. The signal controller 600 determines the voltage application order based on the comparison result, determines suitable waveforms of the output enable signals OE1 and OE2, and outputs the same.

FIG. 10 shows waveforms of an example of first applying the data voltage Vd to the even-numbered pixels of the second pixel row and then to the odd-numbered pixels of the second pixel row.

With reference to FIG. 10, the data voltage Vd1o is first applied to the odd-numbered pixels of the first pixel row and then the data voltage vd1e is applied to the even-numbered pixels of the first pixel row.

The signal controller 600 calculates the average of the odd-numbered image signals and that of the even-numbered image signals at the second pixel row. The signal controller 600 may compare the two calculated averages with the average of the even-numbered image signals of the first pixel row, respectively, and may determine that the average of the even-numbered image signals of the second pixel row is closer to the average of the even-numbered image signals of the first pixel row.

In this case, the signal controller 600 primarily transmits the even-numbered image signals at the second pixel row, over the odd-numbered image signals, to the data driver 500, and interchanges waveforms of the first and second output enable signals OE1 and OE2.

Then, the high voltage interval of the second output enable signal OE2 starts earlier than that of the first output enable signal OE1, and accordingly, the gate signal g4 with respect to the even-numbered pixels of the second pixel row becomes the first gate-on voltage Von, and then the gate signal g3 with respect to the odd-numbered pixels becomes the gate-on voltage Von.

Thereby, the data voltage Vd2e is first applied to the even-numbered pixels of the second pixel row and then the data voltage vd2o is applied to the odd-numbered pixels of the second pixel row, as shown in FIG. 10.

In this manner, the order of applying data voltages to the odd-numbered pixels and the even-numbered pixels of each pixel row may be controlled to thereby reduce power consumption.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An electrophoretic display device, comprising:
a first gate line and a second gate line;
a data line that crosses the first gate line and the second gate line;
a first pixel connected to the first gate line and the data line; and
a second pixel connected to the second gate line and the data line,
wherein the second pixel and the first pixel are on opposite sides of the data line from each other.

2. The device of claim 1, further comprising:
a gate driver to apply a first gate signal to the first gate line and a second gate signal to the second gate line; and
a data driver to apply a data voltage to the data line.

3. The device of claim 2, wherein the data driver comprises at least one integrated circuit chip.

4. The device of claim 3, wherein the gate driver comprises:
a first part connected to the first gate line to apply the first gate signal to the first gate line; and
a second part connected to the second gate line to apply the second gate signal to the second gate line.

5. The device of claim 4, wherein the first part and the second part are disposed at opposite sides of the first and second gate lines from each other.

6. The device of claim 4, further comprising
a signal controller to sequentially supply an image signal with respect to the first pixel and an image signal with respect to the second pixel to the data driver, and to apply an output enable signal to the first part and the second part of the gate driver to control a gate-on voltage time of the first gate signal and the second gate signal.

7. The device of claim 6, further comprising:
a third gate line and a fourth gate line arranged parallel to the first gate line and the second gate line;
a third pixel connected to the third gate line and the data line; and
a fourth pixel connected to the fourth gate line and the data line,
wherein the fourth pixel and the third pixel are on opposite sides of the data line from each other.

8. The device of claim 7, wherein the third gate line is connected to the first part of the gate driver, and the fourth gate line is connected to the second part of the gate driver.

9. The device of claim 8, wherein the gate driver applies the gate-on voltage in the order of the first gate line, the second gate line, the fourth gate line, and the third gate line.

10. The device of claim 9, wherein the data driver applies data voltages in the order of the first pixel, the second pixel, the fourth pixel, and the third pixel.

11. The device of claim 10, wherein a difference between the data voltages with respect to the second pixel and the fourth pixel is smaller than a difference between the data voltages with respect to the second pixel and the third pixel.

12. An electrophoretic display device, comprising:
a plurality of pixels comprising a plurality of pixel rows, a pixel row having odd-numbered pixels and even-numbered pixels;
a first gate line connected to the odd-numbered pixels and to transfer a first gate signal to the odd-numbered pixels;
a second gate line connected to the even-numbered pixels and to transfer a second gate signal to the even-numbered pixels;
a data line crossing the first gate line and the second gate line and connected to both the odd-numbered pixels and the even-numbered pixels in respective pixel rows;
a gate driver to apply the first gate signal and the second gate signal to the first gate line and the second gate line, respectively; and
a data driver to apply data voltages to the data line and comprising at least one integrated circuit chip.

13. The device of claim 12, wherein the gate driver generates a plurality of pairs of first pre-gate signals and second pre-gate signals that are the same as each other, and the gate driver generates the first gate signal using the first pre-gate signal and a first output enable signal and generates the second gate signal using the second pre-gate signal and a second output enable signal.

14. The device of claim 13, wherein an order of applying the data voltages to the odd-numbered pixels and the even-numbered pixels of each pixel row is determined according to a difference between an average data voltage of the odd-numbered pixels and an average data voltage of the even-numbered pixels of a corresponding pixel row, and an average of data voltages that have been applied to the odd-numbered pixels or even-numbered pixels of a previous pixel row.

15. A method for driving an electrophoretic display, comprising:
charging first data voltages to odd-numbered pixels of a pixel row by applying a gate-on voltage to a first gate line via a first part of a gate driver and applying the first data voltages to data lines; and
charging second data voltages to even-numbered pixels of the pixel row by applying the gate-on voltage to a second gate line via a second part of the gate driver and applying the second data voltages to the data lines.

16. The method of claim 15, further comprising:
generating a first pre-gate signal and a second pre-gate signal, each comprising a gate-on voltage interval;
generating a first gate signal by limiting the gate-on voltage interval of the first pre-gate signal with a first output enable signal; and
generating a second gate signal by limiting the gate-on voltage interval of the second pre-gate signal with a second output enable signal,
wherein the first gate signal is applied to the first gate line, the second gate signal is applied to the second gate line, and the gate-on voltage interval of the first gate signal and the gate-on voltage interval of the second gate signal are different.

17. The method of claim 16, wherein the first pre-gate signal and the second pre-gate signal have the same magnitude and duration.

18. The method of claim 16, wherein waveforms of the first output enable signal and the second output enable signal are determined according to a difference between an average data voltage of the odd-numbered pixels and an average data voltage of the even-numbered pixels, and an average of data voltages that have been applied to the odd-numbered pixels or the even-numbered pixels of a previous pixel row.

19. The method of claim 16, further comprising:
obtaining a first average, which is an average of image signals with respect to the odd-numbered pixels of a current row;
obtaining a second average, which is an average of image signals with respect to the even-numbered pixels of the current row;
obtaining a difference between the first average and a third average and a difference between the second average and the third average, the third average being an average of image signals with respect to the odd-numbered pixels or the even-numbered pixels of a previous row; and
determining an order of applying the data voltages to the odd-numbered pixels and the even-numbered pixels of the current row according to the difference between the first average and the third average, and the difference between the second average and the third average.

20. The method of claim 19, further comprising:
outputting image signals with respect to the odd-numbered pixels and the even-numbered pixels of the current row according to the determined order of applying the data voltages; and
determining waveforms of the first output enable signal and the second output enable signal according to the determined order of applying the data voltages.
